(19) United States
(12) Patent Application Publication
(10) Pub. No.: US 2008/0229123 A1
(43) Pub. Date: Sep. 18, 2008

(54) Power transmission line for power supply clusters

(75) Inventors: Chang-Hsing Chen, Taipei County (TW); Ming-Te Chen, Taipei County (TW)

Correspondence Address: Joe McKinney Muncy, PO Box 1364, Fairfax, VA, 22038-1364, US

(73) Assignee: SOLYTECH ENTERPRISE CORPORATION

(21) Appl. No.: 11/723,116

(22) Filed: Mar. 16, 2007

(51) Int. Cl. G06F 1/00

(52) U.S. Cl. 713/300

(57) ABSTRACT

A power transmission line for power supply clusters is electrically connected to a personal computer and a power supply cluster to allow the power supply cluster to receive ON/OFF signals and has a signal delay circuit to generate a time difference for the ON/OFF signals so that the power supply cluster delivers power output in an asynchronous fashion to drive the personal computer.

### FIELD OF THE INVENTION

The present invention relates to a power transmission line for power supply clusters and particularly to a power transmission line for a personal computer which has a plurality of power supplies to activate output power time sequence or so that the power supplies can output power in an asynchronous fashion to drive the personal computer.

### BACKGROUND OF THE INVENTION

The rapid growth of multimedia and the Internet technologies, especially the technologies of CPUs, motherboards and graphic interface adapter cards, causes great increase of power required by personal computers. This is especially true for the personal computer frequently used for playing online games. Once the equipment of the personal computer has been upgraded, the original power supply also has to be upgraded. As the personal computer is upgraded at a very fast pace nowadays, to upgrade the power supply at the same time becomes a heavy burden to users. To overcome this problem, one of the approaches is to take into account of possible future upgrade requirements at the beginning when the personal computer is purchased by selecting a power supply of a greater power capacity. But the power supply of a greater power capacity is more expensive than that of a small or medium size power supply. If the possibility of using the power supply of a greater power capacity in the future is not very sure, users often are reluctant to make such an expensive purchase at the beginning. Another approach is to procure two or more sets of power supplies. Users buy a small or medium size power supply at the initial stage. When the personal computer has to be upgraded and a greater power is needed, another power supply is purchased. Such an approach is different from the multi-set backup power supply assembly adopted on industrial computers. Each power supply in the power supply cluster used on the personal computer has an individual AC input end and DC output end, and the DC output end directly provides electric power to the peripheral devices (such as VGA, HDD, CPU, and the like) in the personal computer. In the backup type power supply for the industrial computer a common power back panel is provided to integrate output power at the DC output end at the front end of all power supplies and distribute to the peripheral devices in the industrial computer.

The technology of composite power supply cluster is available in R.O.C. patent publication No. M292102 and Japan patent publication No. 3122194. In M292102 the power supply cluster has a signal synchronized unit to simultaneously receive ON/OFF signals of a personal computer to activate output power at the same time. Japan patent No. 3122194 has a main power supply to start first, then output power or signal to drive a sub-power supply to start in an asynchronous mode. In practice, M292102 provides a synchronous mode which does not obsolete the existing power supply, and a sub-power supply can be procured and used. However, it has a drawback, namely if the sub-power supply outputs power to drive different peripheral devices, adopting the synchronized actuation mode could cause the peripheral devices getting power earlier than the personal computer. As a result the system cannot distinguish PG signal and machine start could fail. Moreover, the peripheral devices start operations before the PG signal is confirmed could result in improper operations and damages. On the other hand, Japan Patent No. 3122194 adopts asynchronous actuation which can resolve the problems mentioned above. However, it is adaptable only to a newly designed power supply. For the old power supply which does not have the required power or signal output end, the old power supply still has to discarded and replaced during upgrade. Directly buying and using the sub-power supply is not applicable.

### SUMMARY OF THE INVENTION

The primary object of the present invention is to solve the aforesaid disadvantages. The invention provides a power transmission line for power supply clusters of a personal computer which has a plurality of power supplies to activate output power time sequence so that the power supplies can output power in an asynchronous fashion to drive the personal computer.

To achieve the foregoing object, the power transmission line of the invention has one end electrically connected to the personal computer to receive ON/OFF signals and other end divided to form a second end to electrically connect to a main power supply and at least a third end to electrically connect to a sub-power supply. The power transmission line connecting to the sub-power supply has a signal delay circuit so that the sub-power supply can receive the ON/OFF signal at a time difference from receiving of the ON/OFF signals of the main power supply. Thereby asynchronous output power is formed to drive the personal computer.

Another object of the invention is to incorporate the advantages of the techniques of R.O.C. patent publication No. M292102 and Japan patent No, 3122194 so that the main power supply of the old specifications still can be used and an asynchronous actuation mode of power is formed to drive the personal computer.

A further object of the invention is to be adaptable to an external power supply. The power transmission line of the invention can be coupled with a connection dock installed on a face panel of the personal computer so that the power supply cluster is not restricted inside the personal computer. Thus the limited internal space of the personal computer can be released for more flexible use.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the invention adopted for a single set sub-power supply.

FIG. 2 is a structural block diagram of the invention adopted for a single set sub-power supply.

FIG. 3 is a perspective view of the power transmission line of the invention adopted for a single set sub-power supply.

FIG. 4 is a schematic view of the invention adopted for multi-set sub-power supplies.

FIG. 5 is a perspective view of the power transmission line of the invention adopted for multi-set sub-power supplies.

FIG. 6 is a chart showing start time sequence adopted for multi-set sub-power supplies according to the invention.

FIG. 7 is a schematic view of the invention adopted for an external sub-power supply.

FIG. 8 is a schematic view for wiring of the power transmission line of the invention adopted for an external sub-power supply.

### DETAILED DESCRIPTION OF THE PREFERRED EMBODIMENTS

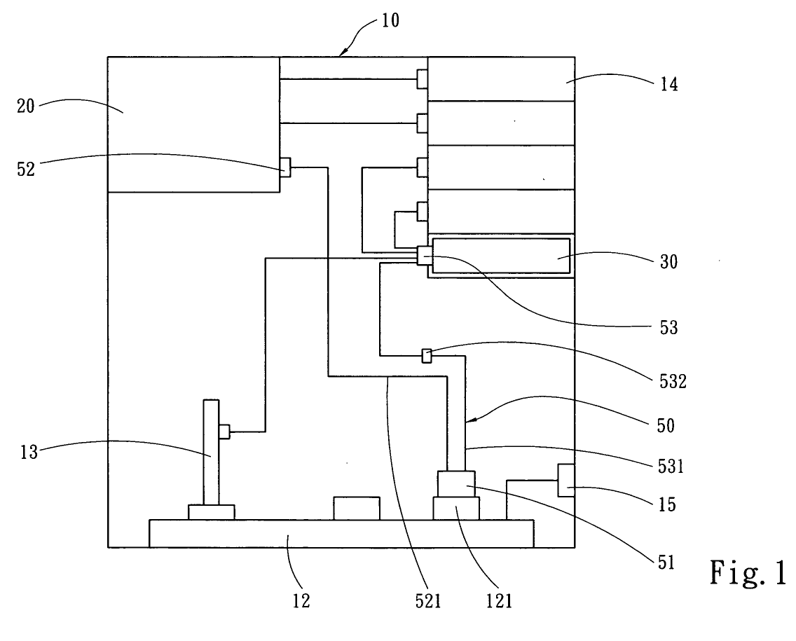

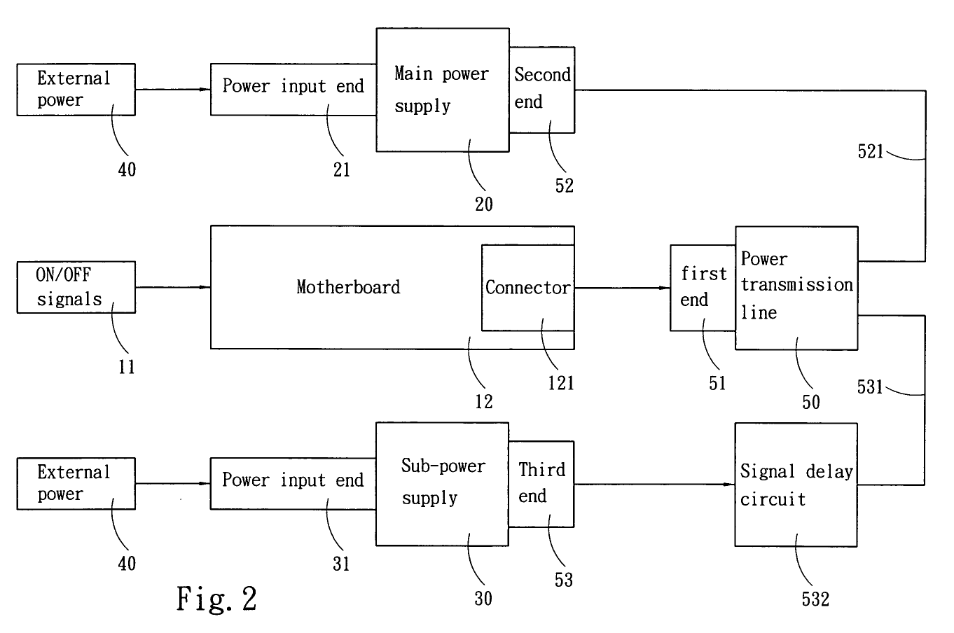

Please refer to FIGS. 1, 2 and 3 for an embodiment of the invention adopted for a single set of sub-power supply. The invention aims for a power supply cluster of a personal computer 10 and a power transmission line 50 thereof. The power supply cluster receives external power 40 and converts the power to drive the personal computer 10. It also receives ON/OFF signals 11 of the personal computer 10 to determine ON/OFF of power output of the power supply cluster. In this embodiment the peripheral devices of the personal computer 10 include a motherboard 12, a hard disk 14 and a graphic adapter card 13 that serve only as examples for discussion. The ON/OFF signals 11 are originated from a power source button 15 on a face panel of the personal computer 10. This technique is known in the art and forms no part of the invention, thus is not a limitation of the invention.

The power supply cluster includes a main power supply 20 and at least one sub-power supply 30. Each power supply has an independent power input end 21 and 31 to receive the external power 40 and convert the power to drive the personal computer 10. The invention further includes the power transmission line 50 which is connected to the main power supply 20 and a connector 121 of 20PIN/24PIN on the motherboard 12 in the personal computer 10. It also may be configured independently. The power transmission line 50 has a first end 51 which is electrically connected to the motherboard 12 to receive the ON/OFF signals 11 output from the power source button 15 and a second end 52 at a branched line of other end to electrically connect to the main power supply 20 and at least one third end 53 to electrically connect to the sub-power supply 30. The second end 52 and third end 53 may be different to match the specifications of the existing main power supply 20 and sub-power supply 30. In the event that the power cord 33 of the main power supply 20 and sub-power supply 30 is wired through a back panel and connected to an internal power conversion circuit for output use, the second end 52 and third end 53 are defined as the DC power output pins of the internal power conversion circuit of the main power supply 20 and sub-power supply 30. If the power cord 33 of the main power supply 20 and sub-power supply 30 is wired through the back panel which has insertion ports, the second end 52 and third end 53 are insertion slots equipped with pin positions. Moreover, the power transmission line 50 may also be an adaptor line. Namely the original power cord 33 of the existing main power supply 20 is directly wired through the back panel and connected to the internal power conversion circuit for output use. The third end 53 of the power transmission line 50 can be connected to the existing main power supply 20 so that the existing main power supply 20 can be continuously used without obsolescence.

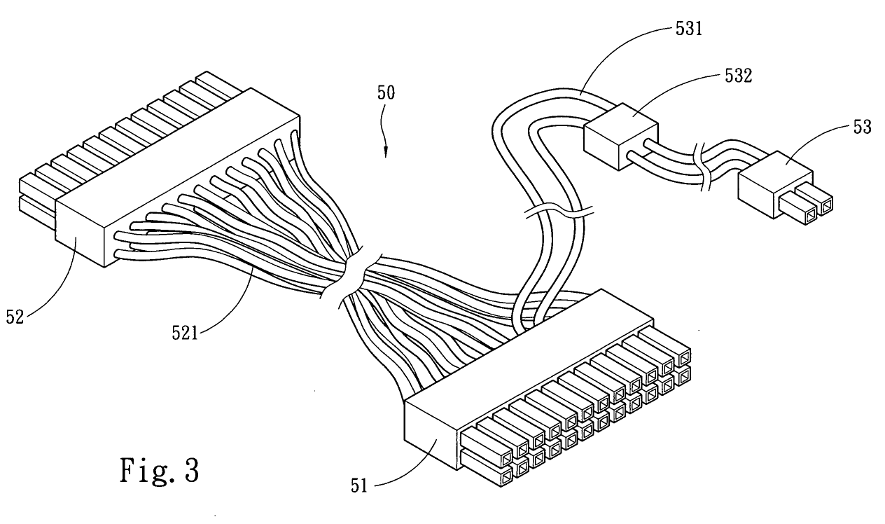

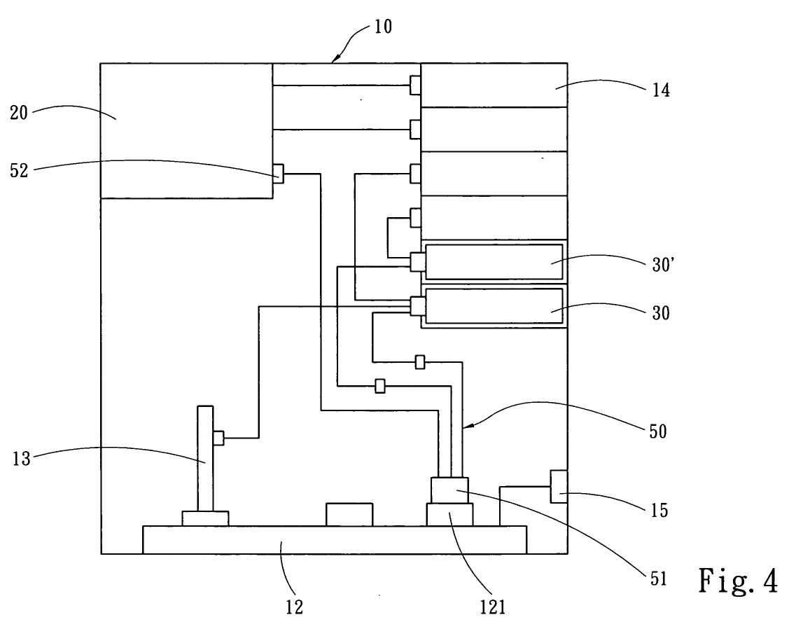

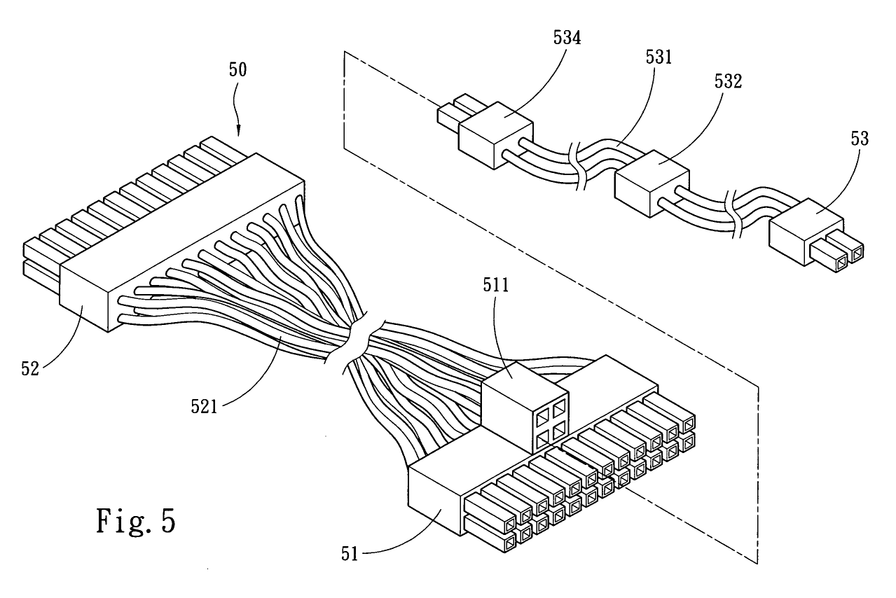

Refer to FIGS. 4 and 5 for the invention adopted for multi-set of sub-power supplies 30 and 30′. The transmission line of the second end 52 and third end 53 may be formed with the same pin position of the first end 51 shown in FIG. 3 and connected, or as shown in FIG. 5 with an extended pin position 511 at the first end 51 to be connected electrically to a transmission line 521 or 531 of the second end 52 or third end 53. Moreover, the transmission line 531 with the extended pin position 511 has a fourth end 534. In a common use mode of the power supply cluster the main power supply 20 outputs power mainly to the motherboard 12 to serve as system power of the personal computer 10. The sub-power supplies 30 and 30′ provide power to the peripheral devices such as the hard disk 14, graphic adapter card 13 and the like. Hence the start power of the main power supply 20 is earlier than the start power of the sub-power supplies 30 and 30′, and they are not synchronized. The start time sequence of the sub-power supplies 30 and 30′ may be synchronous or asynchronous.

The power transmission line 50 of the invention further has a signal delay circuit 532 which may be an integrated circuit, a timer delay circuit, a potential difference transistor switch or the like. The delay circuit 532 is not limited to be located on the power transmission line 50 connecting to the sub-power supplies 30 and 30′. Another option is to have the entire power transmission line 50 connecting to the signal delay circuit 532 first, then have divided current output with the ON/OFF signals 11 of time difference connecting respectively to the main power supply 20 and sub-power supplies 30 and 30′.

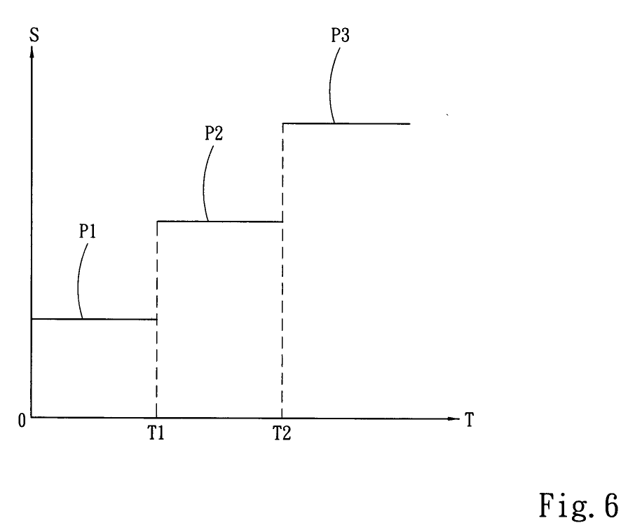

In practice, when the power source button 15 of the personal computer 10 is depressed and the ON/OFF signals 11 are output, the signals are divided through the motherboard 12 and the connector 121 and first end 51 corresponding and connecting to the power transmission line 50. Also referring to FIG. 6, the main power supply 20 is activated to output DC power according the an input time period P1 of the normal ON/OFF signals 11, and the sub-power supplies 30 and 30′ have input time periods P2 and P3 at a time difference relative to the main power supply 20 due to the signal delay circuit 532. Hence the system power of the personal computer 10 is started first, then the power of the peripheral devices is started. Such an asynchronous start mode can prevent machine start failure caused by mistaken judgment of the personal computer 10 and unpredictable damage of the peripheral devices.

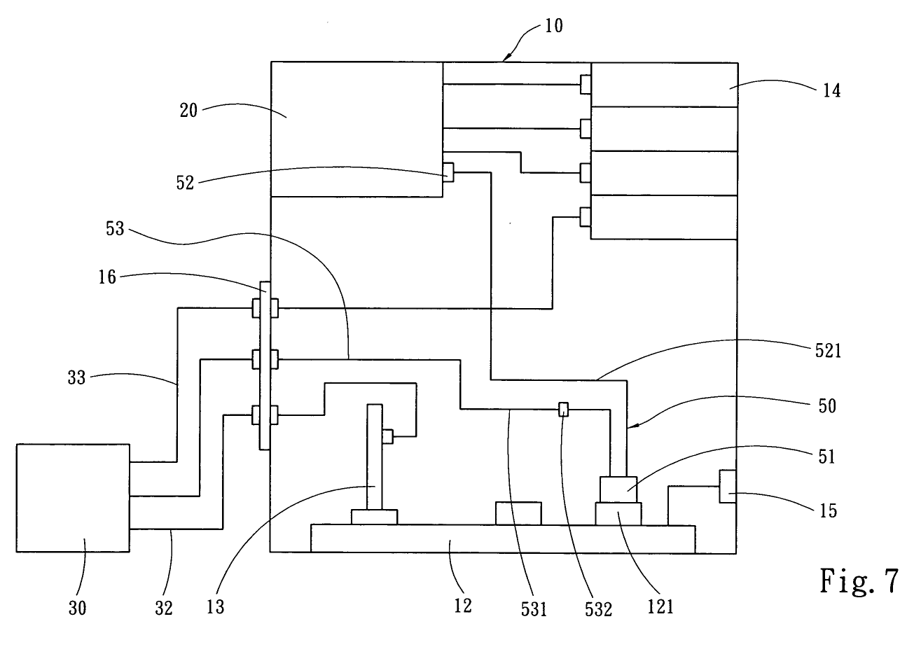

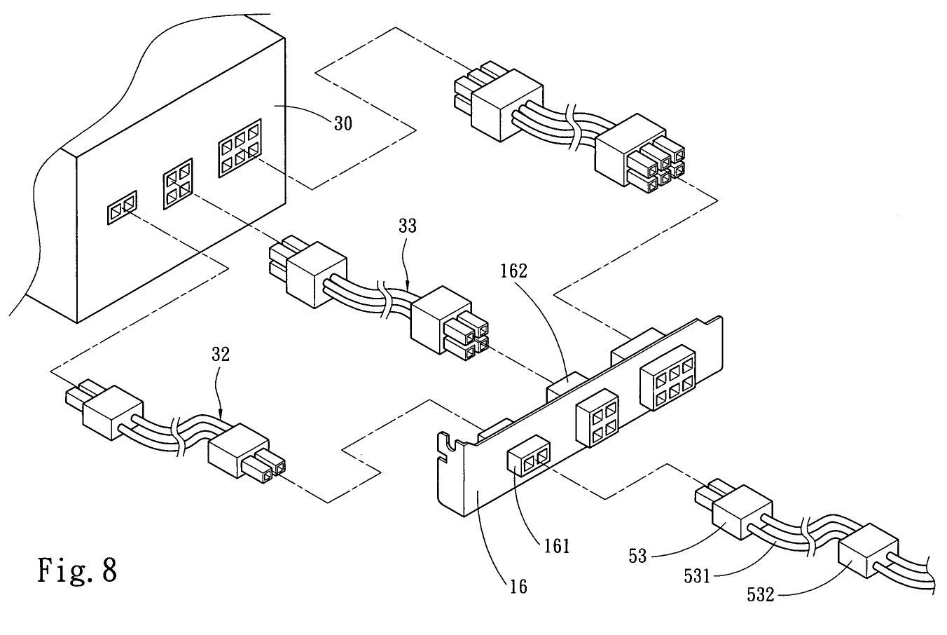

Refer to FIGS. 7 and 8 for a third embodiment of the invention adopted for an external sub-power supply. The invention, aside from adaptable to the power supply cluster built-in the personal computer 10, also can be used for the external power supply. As shown in the drawings of this embodiment, the third end 53 of the power transmission line 50 located on the face panel of the personal computer 10 is electrically connected to the external sub-power supply 30 outside the personal computer 10. The third end 53 also is electrically connected to a connection dock 16 (such as an IO connection dock 16) of the personal computer 10. The connection dock 16 has a power connection port 162 to allow the power transmission line to be connected to the sub-power supply 30 and personal computer 10. The connection dock 16 has a signal connection port 161 and a power connection port 162 mating the third end 53 at the same time. The external power supply also has a signal line 32 and power cord 33 mating the signal connection port 161 and power connection port 162. Hence the external sub-power supply 30, aside from delivering power to drive the external peripheral devices, also can output power through the connection dock 16 to the internal peripheral device of the personal computer 10 and be controlled by the ON/OFF signals 11 of the personal computer 10. As a result, the invention has a greater applicability and can provide more economic effectiveness.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power transmission line for power supply clusters, comprising:
a first end connecting to a personal computer to receive ON/OFF signals of a power supply cluster; and
at least two sets of transmission lines which are connected to the first end to receive the ON/OFF signals synchronously and have a second end and a third end at other ends to be electrically connected to the power supply cluster, either the second end or the third end or both having a signal delay circuit to generate a time difference for the ON/OFF signals output from the second end and the third end to become asynchronous ON/OFF signals.

2. The power transmission line of claim 1, wherein the power supply cluster receives external power and converts the power to drive the personal computer and receives the ON/OFF signals of the personal computer to determine ON or OFF condition of power output of the power supply cluster; wherein the power supply cluster includes a main power supply and at least one sub-power supply, each power supply having an independent power input end to receive the external power and convert the power to drive the personal computer; the first end of the power transmission line being electrically connected to the personal computer to receive the ON/OFF signals and the second end being electrically connected to the main power supply and at least one third end electrically connected to the sub-power supply, at least one power transmission line connected to the sub-power supply or the main power supply having the delay circuit located thereon so that the ON/OFF signals received by the sub-power supply and the ON/OFF signals received by the main power supply have a time difference to form asynchronous output power to drive the personal computer.

3. The power transmission line of claim 1, wherein the transmission lines of the second end and the third end are joined and connected to a pin position same as the first end.

4. The power transmission line of claim 1, wherein the first end has an extended pin position to be electrically connected to the transmission line of the second end or the third end.

5. The power transmission line of claim 4, wherein the transmission line electrically connected to the extended pin position has a fourth end.

6. The power transmission line of claim 1, wherein the power transmission line is a power cord connecting to the main power supply and a motherboard in the personal computer.

7. The power transmission line of claim 1, wherein the third end is located on a face panel of the personal computer and electrically connected to a sub-power supply outside the personal computer.

8. The power transmission line of claim 7, wherein the third end is electrically connected to a connection dock coupled to the personal computer.

9. The power transmission line of claim 8, wherein the connection dock has a power connection port to allow the power transmission line to be connected to the sub-power supply and the personal computer.

10. The power transmission line of claim 2, wherein the transmission lines of the second end and the third end are jointly connected to a pin position same as the first end.

11. The power transmission line of claim 2, wherein the first end has an extended pin position to be electrically connected to the transmission line of the second end or the third end.

12. The power transmission line of claim 11, wherein the transmission line electrically connected to the extended pin position has a fourth end.

13. The power transmission line of claim 2, wherein the power transmission line is a power cord connecting to the main power supply and a motherboard in the personal computer.

14. The power transmission line of claim 2, wherein the third end of the power transmission line is coupled to a face panel of the personal computer to be electrically connected to a sub-power supply located outside the personal computer.

15. The power transmission line of claim 14, wherein the third end is electrically connected to a connection dock located on the personal computer.

16. The power transmission line of claim 15, wherein the connection dock has a power connection port to allow a power cord to be connected to the sub-power supply and the personal computer.
